(19) United States
(12) Patent Application Publication
(10) Pub. No.: US 2026/0056782 A1
(43) Pub. Date: Feb. 26, 2026

(54) System And Method For Artificial Intelligence Enhanced Connector And Flow Generation

(71) Applicant: Nu Computing Abstraction Layer LLC, Bloomfield, NJ (US)

(72) Inventors: Yagmur Sahin, Verona, NJ (US); Melih Abdulhayoglu, Montcalir, NJ (US)

(21) Appl. No.: 19/301,874

(22) Filed: Aug. 15, 2025

Related U.S. Application Data
(60) Provisional application No. 63/685,825, filed on Aug. 22, 2024.

(51) Int. Cl. G06F 9/50; G06N 20/00

(52) U.S. Cl. CPC G06F 9/50; G06N 20/00

(57) ABSTRACT

There is provided a system and method for creation and management of connectors and flow processes in digital applications. The method includes the input of connector and flow data, which the AI processes to identify patterns and optimize functionalities. The AI then trains a model based on the data and enhances its capabilities over time. The results from the AI are supplied back into the system, where the results are used to refine and process connectors and flows further. This system ultimately enables automated communication, such as sending messages via third party connectors, and provides users with the ability to create custom flows effortlessly, leveraging AI-driven insights and automation for improved efficiency and performance.

### CROSS REFERENCE TO RELATED APPLICATIONS

This application claims the benefit of and priority to U.S. Provisional Application No. 63/685,825 filed on Aug. 22, 2024 and incorporated herein by reference in its entirety.

### FIELD OF THE INVENTION

The present invention relates to connectivity to a platform, and more particularly to managing digital connectors and workflows.

### BACKGROUND

Currently, the creation and management of connectors and workflows were and are predominantly manual processes. Below is a description of these traditional methods:

Manual Configuration: The traditional approach involves developers manually writing code to create and configure connectors (interfaces that allow different software systems to communicate with each other) and workflows (sequences of tasks that process data between these systems). This process requires in-depth knowledge of the APIs of the systems being integrated and often involves trial and error to handle various edge cases and error handling scenarios.

Use of Predefined Templates: Some systems offer predefined templates for common connectors and workflows, which developers can use as a starting point. However, customization of these templates is still largely a manual process, requiring developers to adjust the code to meet specific operational needs and integration contexts.

Scripting and Programming: Developers use various scripting and programming languages to establish the logic and sequences required in workflows. This method demands a significant amount of coding and debugging, especially as the complexity of integrations increases.

Middleware Solutions: Middleware solutions, like Enterprise Service Buses (ESB) and integration platforms, provide some level of abstraction and tools to aid in connector and workflow creation. However, these platforms still require manual setup and tuning by skilled developers or system integrators.

These older methods had various limitations, described as follows. 1.) Time-consuming, as each new integration or workflow setup requires considerable developer time and resources, slowing down project timelines. 2.) Error-prone: Manual coding and configuration are susceptible to human errors, which can lead to bugs and system failures. 3.) Scalability Issues: As the number of integrations increases, managing and updating them manually becomes increasingly unwieldy and complex. 4.) Skill Dependency: These methods heavily rely on the technical skills of developers who understand both the integration platforms and the business logic of the workflows.

These traditional methods, while effective to some extent, often lack the efficiency, speed, and adaptability that modern fast-paced software development environments demand. The older and existing methods for creating and managing connectors and workflows also have several disadvantages that can impact the efficiency and scalability of software development projects. The primary drawbacks are described below:

High Time Consumption: Manual coding and configuration are inherently time- consuming. Developers spend significant amounts of time writing, testing, and debugging code for each new connector and workflow. Each integration requires individual attention, which can delay other aspects of development and increase overall project timelines.

Increased Complexity and Maintenance Overhead: As the number of integrations grows, the complexity of managing all the connectors and workflows also increases. This can lead to a higher maintenance overhead, as each integration may require updates and troubleshooting. Scalability becomes a challenge, as adding more integrations often means a linear increase in maintenance and management workload.

Dependence on Specialized Skills: Traditional methods require developers to have specialized knowledge of the APIs and systems involved. This dependence on specialized skills can limit the pool of developers who can effectively work on the project. Training new team members to manage these integrations can be costly and time-consuming.

Error Prone: Manual processes are susceptible to human error. Mistakes in coding or configuration can lead to bugs, system failures, or data inconsistencies. Debugging and fixing these errors can be difficult, especially if the workflows and connectors are complex.

Lack of Adaptability: Changing business requirements or updates in external systems' APIs can necessitate frequent updates to the connectors and workflows. Manual updates are slow and can lead to downtime or service interruptions. Adapting to new technologies or integrating innovative solutions is slower, which can hinder a company's ability to stay competitive.

Cost Inefficiency: The labor-intensive nature of manual integration processes can lead to higher costs in terms of both time and money. The need for frequent updates and maintenance, combined with the potential for downtime caused by errors, can further increase operational costs.

These disadvantages highlight the need for a more efficient, automated approach which aims to mitigate these issues by leveraging artificial intelligence (AI) to streamline and enhance the integration process.

### SUMMARY OF THE INVENTION

The AI-Enhanced Connector and Flow Generation System addresses these limitations by automating the generation and management of connectors and workflows, significantly improving the integration process in terms of reliability, scalability, and ease of use.

The present invention of an AI-enhanced connector and flow generation system relates to “Parject as a Service.” (“PaaS”). This product is a backend package designed for companies that operate as workflow automation builders or use flow builders. It includes advanced features for managing API interactions and user authentications across various services, aiming to enhance backend integrations and automation capabilities. The present invention AI-Enhanced Connector and Flow Generation System is intended to integrate within this service to improve the automation of creating and managing connectors (termed as “Parjects”) and flows/sub-flows, thus optimizing the processes involved in setting up and maintaining these connections.

The AI-Enhanced Connector and Flow Generation System is designed to automate and optimize the creation and management of connectors and flow processes in digital applications. This system utilizes artificial intelligence to train on existing connectors, termed “Parjects,” and flow/subflow structures to generate new, efficient, and contextually relevant connections and workflows. The primary purpose of this invention is to streamline the integration process for applications that rely on numerous external services and APIs, reducing manual coding effort and potential for human error, while enhancing customization and scalability.

The AI-Enhanced Connector and Flow Generation System is designed to automate and enhance the process of creating and managing digital connectors and workflows, which are integral to various software applications and services. The core of the system involves an artificial intelligence (AI) that learns from existing connectors (referred to as “parjects”) and flows/subflows, improving its ability to generate these components more efficiently and accurately over time.

The present invention streamlines the process of connector and workflow creation in software systems, reducing the manual effort required by developers and increasing the speed and reliability of setup and maintenance processes. By integrating AI into the generation of these components, the system aims to minimize errors and optimize performance, making the development of complex integrations more accessible and efficient.

The present invention is a system and method for creation and management of connectors and flow processes in digital applications. The method includes the steps of the inputting of connector and flow data and processing the input and flow data by an artificial intelligence process. The method then identifying patterns by the artificial intelligence process and optimizing functionalities by the artificial intelligence process. The method trains a model by the artificial intelligence based on the input and flow data and enhances the capabilities of the model by the artificial intelligence over time. The method then supplies the results from the artificial intelligence back into the system. The method refines and processes connectors and flows by the results.

In an embodiment, the method includes enablement of automated communication and messages by third party connectors, such as video platforms.

In an embodiment, the method includes a step of providing users with the ability to create custom flows. In another embodiment, the method of the present invention, includes the step of leveraging artificial intelligence driven insights and automation for improved efficiency and performance.

### BRIEF DESCRIPTION OF THE DRAWINGS

FIG. 1 illustrates the entities in the present invention Parjects based application development system.

FIG. 2 illustrates the application development lifecycle using Parjects.

FIG. 3 is overall schematic of abstraction-based development system provided by Parjects.

FIG. 4 is a schematic of an application instance scenario with different Parject each is supported via different API providers.

FIG. 5 is a schematic illustration of the connections of a computing system.

FIG. 6 is a schematic of the present invention.

FIG. 7 is a schematic of the present invention.

### DETAILED DESCRIPTION

The present invention is based on a computing abstraction layer which is formed of Parjects for any set of capabilities in the world. Parject based application development system has a set of entities that makes the platform available for end users and application developers.

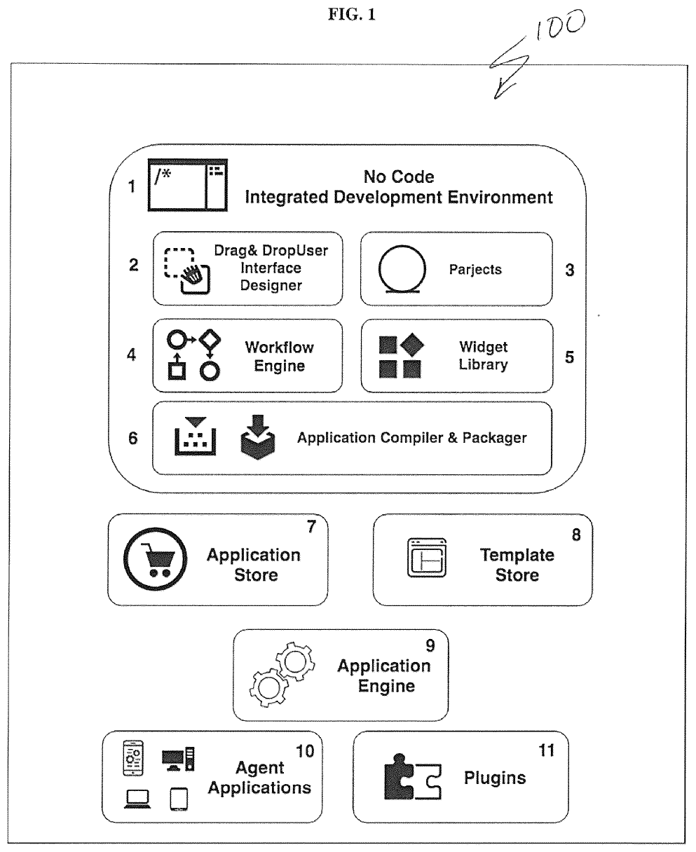

FIG. 1 shows entities of an object based application development system. A definition of each of the entities in FIG. 1 is provided below, with numbers referencing corresponding items and features in the accompanying drawing.

No Code Integrated Development Environment (IDE) (1): The no code integrated development environment is a main tool to give application developers ability to create applications over Parject based computing abstraction layer. IDE manages application and template development. Application project creation and development via drag and drop user interface designer, Parjects and workflow engine are the main practices of application development over IDE. Application compilers and packagers for web, mobile and desktop applications are provided via IDE.

Drag and Drop User Interface (UI) Designer (2): Application user interfaces for any type of application are created over IDE using a UI Designer which provides capabilities for creating different pages for different use cases. UI Designer module works with drag & drop capability using widget library. Each widget can be added via drag & drop interaction and page design can be done with mouse and keyboard controls. Those controls include positioning, sizing, styling, cut, copy, paste, group and other configurations which can be done over widgets. IDE activities are completely done without coding and targets also non-coder developers as well as experienced ones.

Parjects (3): Parjects are the main components of the present invention and are the software part or portion as an object. Parjects represent a variety of capabilities of worldwide APIs and plugins which work on desktop and mobile devices. Parjects are used over IDE as they are added to application projects and used as capability set in the applications. Parjects are formed of a set of attributes, interactions and callback events. Attributes represents the data model and relationships with other Parjects. Interactions represents the interactions that an end user(s) can do over a data content. Callback events are the system interactions that triggers from system state changes. Parjects are software parts as objects, and they provide a large set of capabilities to create any type application. Parjects are created via conversion of APIs and each Parject can have more than one API provider. The computing abstraction layer creates a complete abstraction via Parjects over APIs. An application is developed using Parjects 3 and packaged once. Then each application buyer has freedom to configure their application instance with different provider per Parject or Parject group than other buyers.

Workflow Engine (4): Parject based application development system enables development of applications using UI elements and Parjects 3. The application and business logic of application and connection between them is provided via workflow engine. Workflow engine 4 has a set of activities for: using Parject 3 interactions via gathering inputs from UI widgets or other data sources like old Parject interaction results or variables; displaying Parject interaction results and their data on UI widgets or saving them for future usages; UI manipulation capabilities like page direction, changing UI behaviors on runtime; callback, widget and error event trigger handling. The workflow engine 4 provides application developers chance of easily changing the application behavior and ability to create any type of application for any type use cases.

Widget Library (5): Parject based application development system enables development of applications using UI widgets, Parjects 3 and workflow engine 4. UI Design of web, mobile and desktop applications are managed completely using widget library 5. Each widget is added to designer via drag & drop action and configured over designer. Each widget has a set of properties to be configured at application development time, widget events to reflect end user activities to workflow engine and a set of functions to give ability to change its property configurations at application run time. Widgets are customized to Parject 3 and other widget interactions to make the development environment without coding and minimum user interaction for any type application developers.

Application Compiler & Packager (6): The applications developed over IDE are compiled and converted to an application bundle depending on selected platform. It can be a web application, a desktop application or it can be a mobile application or all of them. The applications are compiled into related platform's application and packaged from IDE.

Application Store (7): The packaged applications developed over IDE are versioned and deployed to application store 7 if application developer wants to sell it. The application store 7 is the main container for applications which are developed for sale. Application buyer can buy applications and configure them according different licensing options, and Parject providers.

Template Store (8): The applications developed over IDE can be packaged as application template for other developers to use it as a base and edit it. Application templates are published on template store 8 for sale. Application developers who do not want to start from scratch will have ability to purchase a template and start development on it. Templates are just the packaged versions of application projects.

Application Engine (9): The provisioned applications run on the application engine 9. For each application, a containerized instance is prepared, and the application is run over it. All the resource management, scalability and maintenance of application is managed by application engine.

Agent Applications (10): Parjects 3 represent capabilities of worldwide APIs as well as any computational IP connected device capabilities. For each platform there is an agent application that provides exposition of device capabilities as Parjects 3. Agent applications are responsible for plugin management and communication with devices.

Plugins (11): Each capability that works on IP connected devices is represented as plugin and run by the agent application 10. Any new plugin 11 can be added to system or removed without changing agent application 10.

### Application & Template Development

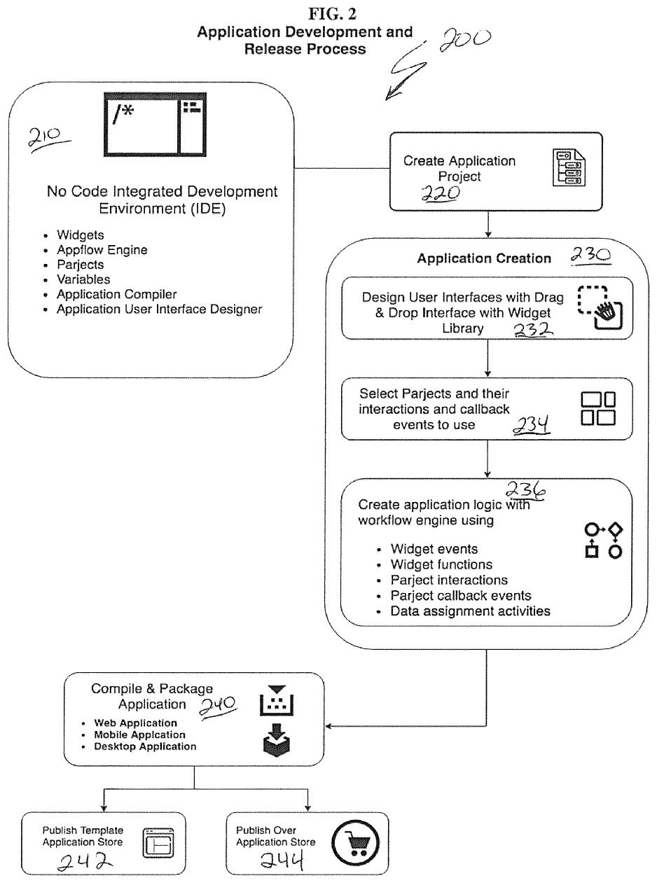

The application and template development is now described with reference to FIG. 2 for how the application development process 200 using Parjects 3 is managed. Parject based computing abstraction layer exposes as outputs like applications or templates. The application or template development process is very similar and the following activities are done during that process. Within the No Code Integrated Development environment 210, there exists the widgets, appflow engine, Parjects 3, variables, application compiler 6, and application user interface designer. The application project is created 220 according to purpose of application via platform selection web, mobile or desktop. Then, the Application development process includes a set of activities which depends on application, as shown with application creation step 230. Within the Application creation 230, there is design of user interfaces with a drag & drop designer and widget library 232, then adding Parjects 3 into project, by selecting Parjects 3 and their interactions and call back events to use 234; and then creating application logic with a workflow engine 236 combining one or more or all of: widget capabilities, such as widget events and widget functions with Parject interactions and callback events, and data assignment activities. After application creation is completed, the application development and release process 200 then performs compiling and packaging the application according to platform selection 240, including web application, mobile application, and desktop application. Depending on output, the process 200 includes publishing it as template for targeting application developers 242 or publish it as an application for targeting any type application buyers 244.

### Application Run Time Lifecycle over Parjects

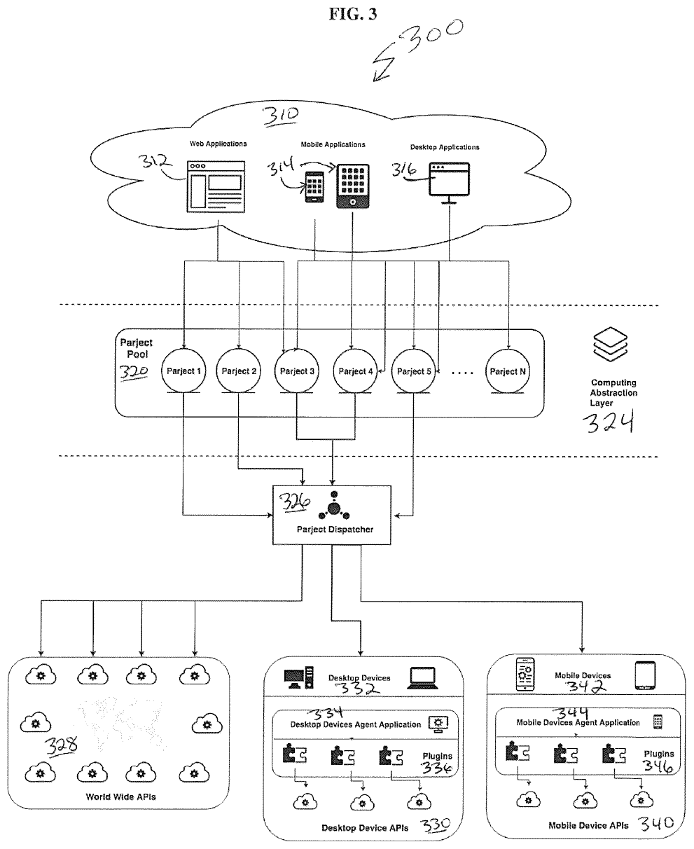

Referring to FIG. 3 for a description of how the Parject based computing abstraction layer 324 works during an application's lifecycle 300. The applications of type web application (312), mobile application (314) or desktop application (316) are created over IDE then packaged and published to application store. Each packaged application is provisioned with a specific configuration according to selection of application buyer. Each provisioned application runs on a cloud platform 310 which is based on Parject 3 based computing abstraction layer, 324, that is formed by a pool 320 of Parjects indicated by Parject-1 through Parject-N. Application interactions depending on the application logic is managed by application workflow engine. Application interactions are including Parject interactions as steps in the workflow engine 4. The flow of a Parject interaction can be illustrated as: Application logic requires an interaction which creates a Parject interaction usage. This Parject interaction goes over computing abstract layer 324 and sends a request to Parject Dispatcher module 326. The Parject Dispatcher module 326 checks the application provisioning information and finds the provider of related Parject. The Parject Dispatcher module 326 receives the provider mapping request of related Parject interaction. Depending on the type of request, it is sent to provider API (328,330,340). It can be either one that goes over a device-based API (330,340) or cloud API (328). Device based APIs are used for managing physical mobile (342) or desktop (332) devices. The device management capabilities are exposed via desktop agent applications (334) and mobile agent applications (344). Those agent applications (334,344) provide communication between Parject dispatcher (326) but their capabilities are exposed via desktop agent plugins (336) for desktop devices (332) and mobile agent plugins (346) for mobile devices (342). The result of Parject interaction is returns from the same path and come to Parject Dispatcher module (326) with a response mapping. The response is transmitted to application and application workflow logic continues to run.

### Applications' Lifecycle with Different Parject Providers

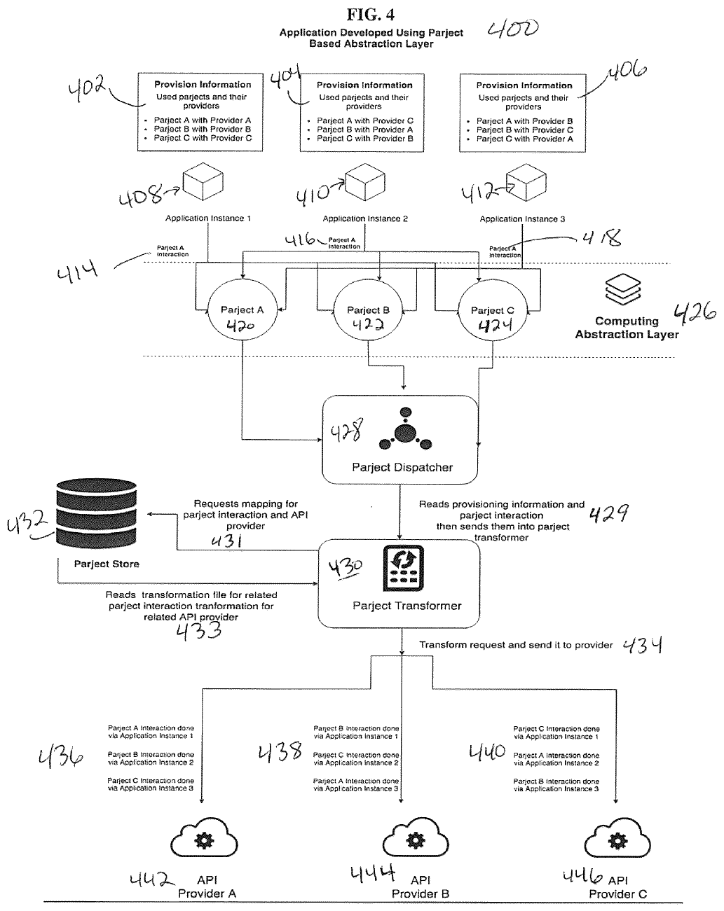

The applications' lifecycle with different Parject providers will now be described with reference to FIG. 4. As described in FIG. 4, there is shown how an application instance can work with different Parject providers. Applications developed over Parject based computing abstraction layer provides an abstract environment which enables same application to work with different API providers without editing anything in the application itself. An application 400 is created once but each instance is provisioned separately and has ability to be configured different. This capability forms the core part of this invention. Each application is only aware of Parjects which are the doors of an application to world APIs. A Parject can have more than one API provider with same capabilities and each provisioned instance of an application can use different providers for same application. However, each application instance behaves same and does same thing. This is achieved with Parject based computing abstraction layer (426) modules.

Referring again to FIG. 4, the following three flow paths simulates an application with three different application instances with three different Parject usages with three different provider provisioning. For the first path, Flow Path 1, the precondition is set as follows: Application Instance 1 (408) uses three Parject interactions which are interactions of Parject A (420), Parject B (422) and Parject C (424). Application Instance 1 (408) is provisioned with Provision Information 1 (402). The Parject interaction of A, Parject Interaction of B and Parject interaction of C is called from application instance. The Parject interactions are reflected to Parject Dispatcher (428) over Parject based computing abstraction layer (426) with Provisioning Information 1 (402). The Parject Dispatcher module 428 reads the Provisioning Information 1 (402) to get the provider information for used Parject. The Parject Dispatcher 428 passes Provisioning Information 1 (402) to Parject Transformer (430) module. Step (429). The Parject Transformer (430) module sends provider information and used Parject interactions to Parject Store (432) to get the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and send them to providers. Step (434). The request for interaction of Parject A is sent and communicated to API Provider A (442). Step (436). The request for interaction of Parject B is send and communicated to API Provider B (444). Step (438). The request for interaction of Parject C is send to API Provider C (446). Step (440). The responses from each of API Providers (442, 444, 446) follows the same path from opposite direction and finalizes as the Application Instance 1 (408) interaction result.

For the second path, Flow Path 2, the precondition is set as follows: Application Instance 2 (410) uses three Parject interactions which are interactions of Parject A (420), Parject B (422) and Parject C (424). Application Instance 1 (410) is provisioned with Provision Information 1 (404). The Parject interaction of A, Parject Interaction of B and Parject interaction of C is called from application instance. The Parject interactions are reflected to Parject Dispatcher (428) over Parject based computing abstraction layer (426) with Provisioning Information 2(404). The Parject Dispatcher module 428 reads the Provisioning Information 2 (404) to obtain the provider information for used Parject. The Parject Dispatcher passes Provisioning Information 2 (404) to Parject Transformer (430) module. Step (429). The Parject Transformer (430) module sends provider information and used Parject interactions to Parject Store (432) to obtain the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and sends them to providers. Step (434). The request for interaction of Parject A is send to API Provider C (446). Step (440). The request for interaction of Parject B is sent to API Provider A (442). Step (436). The request for interaction of Parject C is send to API Provider B (444). Step (438). The responses from API Providers (442,444,446) follows the same path from opposite direction and finalizes as the Application Instance 2 (410) interaction result.

For the third path in FIG. 4, Flow path 3, the precondition is set as follows: Application Instance 3 (412) uses 3 Parject interactions which are interactions of Parject A (420), Parject B (422) and Parject C (424). Application Instance 1 (412) is provisioned with Provision Information 1 (406). The Parject interaction of A, Parject Interaction of B and Parject interaction of C is called from application instance. The Parject interactions are reflected to Parject Dispatcher (428) over Parject based computing abstraction layer (426) with Provisioning Information 3 (406). The Parject Dispatcher module reads the Provisioning Information 3 (406) to obtain the provider information for used Parject. The Parject Dispatcher passes Provisioning Information 3 (406) to Parject Transformer (430) module. Step (429). The Parject Transformer (430) module sends provider information and used Parject interactions to Parject Store (432) to get the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and send them to providers. Step (434). The request for interaction of Parject A is sent and communicated to API Provider B (444). Step (438). The request for interaction of Parject B is send and communicated to API Provider C (446). Step (440). The request for interaction of Parject C is sent and communicated to API Provider A (442). Step (436). The responses from each of API Providers (442,444,446) follows the same path from opposite direction and finalizes as the Application Instance 3 (412) interaction result.

The present invention has numerous advantages as it provides a new computing abstraction layer for all over the world's computational capabilities. This invention provides for API providers to reach many audiences with increasing their value with combination with other APIs that they are not able realize. It removes walls between products as representing them as Parjects. Further, the present invention provides the advantage of a no code application development environment over computational abstraction layer of Parjects in which updating, orchestrating, and testing applications is very easy and does not require deep technical knowledge. Moreover, deploying and running applications requires no effort. The customization of applications are very effortless using applications templates.

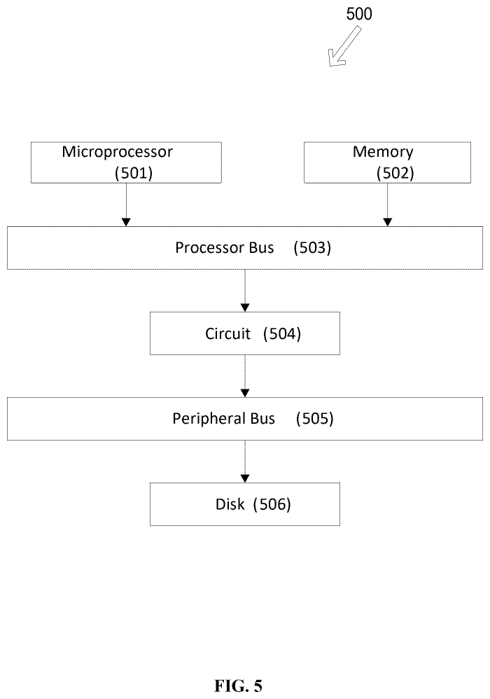

The present invention is used with the following FIG. 5 of computer systems, components, and internet access. FIG. 5 illustrates a system of a computer or device which includes a microprocessor 501 and a memory 502 which are coupled to a processor bus 503 which is coupled to a peripheral bus 505 by circuitry 504. The bus 505 is communicatively coupled to a disk 506. It should be understood that any number of additional peripheral devices are communicatively coupled to the peripheral bus 505 in embodiments of the invention. Further, the processor bus 503, the circuitry 504 and the peripheral bus 505 compose a bus system for computing system 500 in various embodiments of the invention. The microprocessor 501 starts disk access commands to access the disk 506. Commands are passed through the processor bus 503 via the circuitry 504 to the peripheral bus 505 which initiates the disk access commands to the disk 506. In various embodiments of the invention, the present system intercepts the disk access commands which are to be passed to the hard disk.

The AI-Enhanced Connector and Flow Generation System leverages artificial intelligence to automate the creation and management of digital connectors (termed “parjects”) and workflows. The system is designed to significantly reduce the manual effort involved in integration tasks, while increasing efficiency, accuracy, and adaptability. A detailed description of its construction, design, operation, and preparation follows.

### Construction and Design

### AI Training and Model Development

The system utilizes machine learning models trained on a large dataset of existing connectors and workflows. This training involves analyzing patterns, configurations, and the outcomes of previous integrations to understand best practices and common pitfalls.

The AI models are designed to adapt to various integration requirements and can update their knowledge base with new data continuously.

### System Architecture

The core of the system is the AI engine that handles the generation of connectors and workflows. This engine is supported by a user interface (UI) where users can input specific requirements and parameters for their desired integrations. The backend is connected to a database that stores templates, user inputs, and historical data of connectors and workflows which the AI uses for learning and reference.

### Operation

### User Interaction

Users start by inputting their requirements into the UI, specifying the systems they wish to connect and the type of workflow they need. Users can also specify constraints and business rules. The AI uses this information to generate a draft connector and workflow, which it presents to the user for review.

### AI-Powered Generation

Based on the input from the user and its trained models, the AI generates the necessary code and configuration for the connectors and workflows. It automatically sets up error handling, logging, and compliance with best practices, ensuring robustness and reliability.

### Review and Customization

Users can review the generated connectors and workflows, making adjustments as needed. The AI learns from these adjustments to improve future generations. Once finalized, the configurations can be deployed directly to the user's environment.

### Continuous Learning and Updating

The system continually learns from new integrations and user feedback, allowing it to refine its algorithms and improve the quality of generated connectors and workflows over time.

Users can opt to receive updates and enhancements automatically, keeping their integrations up-to-date with the latest best practices.

### Preparation

### Data Collection and Model Training

Prior to deployment, substantial data collection is necessary to train the AI models. This includes gathering examples of successful and unsuccessful integrations, configurations, and user feedback. The training process involves typical machine learning tasks such as feature extraction, model selection, and cross-validation to ensure the models are generalizable and effective.

### Enabling Reproduction of the Invention

The detailed design documents, along with the description of the AI algorithms and the system architecture, provide sufficient information for a professional in the field of AI and software integration to understand, build, and deploy a similar system. This includes specifics on the machine learning techniques used, the architecture of the system, the user interface design, and the interaction flow between the AI and the end-users. By following these guidelines, a skilled professional could replicate the AI-Enhanced Connector and Flow Generation System, ensuring it meets the practical requirements and challenges of modern software integration tasks.

The AI-Enhanced Connector and Flow Generation System has demonstrated several unexpected results and benefits that significantly deviate from traditional methods of managing connectors and workflows. Some of the outcomes include:

### Dramatic Reduction in Development Time

One of the unexpected results was the extent to which development and integration time was reduced. While some efficiency improvements were anticipated, the AI system exceeded expectations by automating the bulk of the coding and configuration tasks, cutting down integration times by up to 70% compared to traditional methods.

### High Accuracy in First-Attempt Success

The AI's ability to generate connectors and workflows that work correctly on the first attempt was notably higher than expected. Traditional methods often require multiple iterations and debugging sessions. The AI system's use of historical data and learned patterns enabled it to anticipate and avoid common pitfalls, leading to a higher rate of first-time success.

### Adaptive Learning Capabilities

The system displayed unexpected adaptability in learning from less common and more complex integration scenarios. It was able to understand and integrate niche systems and uncommon APIs with surprising effectiveness, a task that typically would require specialized developer knowledge and considerable manual effort.

### Enhanced Error Handling and Predictive Adjustments

The AI system not only adheres to best practices for error handling but also has shown the capability to predict potential points of failure based on the integration context and proactively adjust the workflow or connectors to mitigate these risks. This preemptive adjustment was a significant advancement over traditional methods, where error handling is reactive.

### Customization Without Manual Coding

Traditionally, achieving a high level of customization in connectors and workflows involves extensive manual coding. However, the AI system provided an unexpected level of customization through its interface, allowing users to specify detailed requirements that the AI could interpret and implement automatically. This feature drastically reduced the need for manual intervention while allowing for highly specific integration outcomes.

These unexpected results highlight the transformative potential of the AI-Enhanced Connector and Flow Generation System in the field of software integration, offering not only improvements over existing methods but also introducing new capabilities that were previously unachievable with traditional approaches.

The Al-Enhanced Connector and Flow Generation System is a sophisticated software program designed to automate the creation and management of digital connectors (termed “Parjects”) and workflows. It has a purpose to simplify and streamline the process of integrating different software systems, reducing the manual effort typically required for such tasks.

Some of the key features with the present invention include the following items.

AI-Powered Automation: Utilizes machine learning algorithms to learn from existing connectors and workflows, enabling it to generate optimized and efficient integration setups automatically.

Customizable Workflows: Offers users the ability to define specific requirements and parameters, which the Al uses to create tailored connectors and workflows that meet unique business needs.

Error Handling and Optimization: Incorporates advanced error handling strategies and predictive adjustments to improve the reliability and performance of integrations.

### Purposes of the Software

Integration Simplification: Greatly reduces the complexity involved in setting up and managing integrations between different software platforms, APIs, and systems.

Speed and Efficiency: Accelerates the development and deployment of integrations, enabling faster project completion and quicker response to changing business requirements.

Reduction of Manual Coding: Minimizes the need for manual coding and configuration, allowing developers to focus on more strategic tasks.

Scalability: Supports scaling up of integration efforts without proportional increases in resource allocation or complexity.

Learning and Adaptation: Continuously improves its integration capabilities based on new data, user feedback, and evolving integration scenarios.

This software is for businesses that require frequent and complex integrations across various platforms and services, although other uses are within the scope. It is particularly beneficial in environments where reducing time-to-market and operational efficiency are critical. Additionally, the system's ability to learn and adapt makes it suitable for dynamic industries that experience frequent changes in technology and business processes.

The AI-Enhanced Connector and Flow Generation System introduces several novel aspects that distinguish it from existing software solutions on the market, particularly in the field of digital integration and automation. Here are the key innovative features of the software:

### AI-Powered Connector and Workflow Generation

Unlike traditional integration platforms that rely heavily on manual configuration, this software employs AI to automate the generation of connectors and workflows. The AI learns from a vast array of existing data points and is able to predict the most efficient configurations, which significantly reduces the setup time and potential for human error.

### Dynamic Learning and Adaptation

The system continuously improves its performance through machine learning algorithms that adapt based on new integrations, user feedback, and changes in external systems' APIs. This feature is relatively unique in the market, as many existing solutions require manual updates to handle new integration scenarios.

### Predictive Error Handling

This software anticipates potential points of failure in integrations and automatically adjusts configurations to prevent errors before they occur. This proactive approach to error management is a significant advancement over the reactive error handling methods commonly found in current integration tools.

### High Customization with Minimal Coding

The system offers a high degree of customization without the need for extensive coding. Users can input detailed requirements, and the AI generates a tailored solution, adapting existing templates or creating new ones as needed. This contrasts with other tools that offer limited customization unless extensive manual coding is undertaken.

### Integration of Uncommon Systems

The AI's capability to learn and integrate less common systems and APIs is a notable feature. It can handle niche or legacy systems that typically pose challenges for more standardized integration platforms, making it highly versatile.

### Overcoming Deficiencies in Existing Software

Reduction of Complexity: Many integration solutions require specialized knowledge or extensive training. This software simplifies the process, making it accessible to users with varying levels of technical expertise.

Speed and Efficiency: By automating much of the configuration work, the software reduces the time required to deploy integrations from weeks to days or even hours, offering significant productivity gains.

Scalability: Traditional tools often struggle to scale efficiently as the number of integrations grows. This system's Al-driven approach allows it to scale more seamlessly, handling an increasing number of integrations without a corresponding increase in complexity or resource demand.

Adaptability: The ability to quickly adapt to changes in technology or business requirements is a critical advantage. This software adjusts to new integration scenarios without needing constant manual updates, ensuring it remains effective over time.

These novel aspects make the AI-Enhanced Connector and Flow Generation System a cutting-edge tool in the realm of digital integrations, addressing and overcoming many of the limitations found in existing software products.

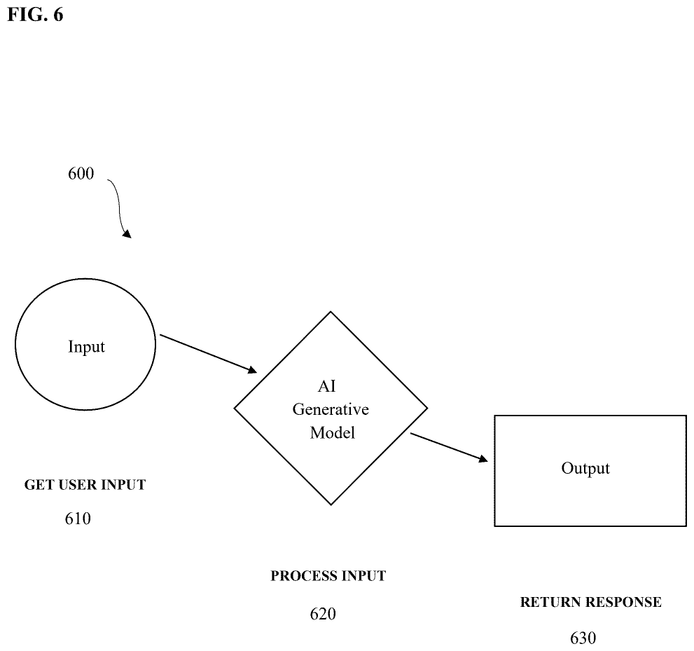

Referring to FIG. 6, there is shown a schematic of the present invention 600. First, the user input is gathered (Step 610). Then, the AI generative model processes the input. In step 630, the output is returned in the response.

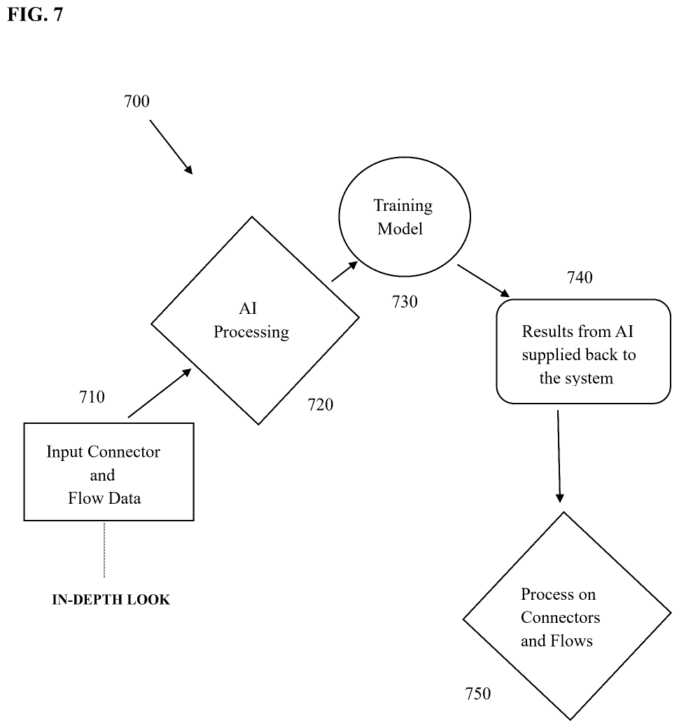

In FIG. 7, there is shown a more in depth schematic of the present invention 700. The input connector and flow data 710 sends and communicates the information to the AI processing step 720, which communicates with an AI training model 730, with results 740, and refine processes 750. One or more servers may be used for storing data and the training AI models.

The AI-Enhanced Connector and Flow Generation System 700 is designed to streamline the creation and management of connectors and workflow processes. The present invention and method begins with the input of connector and flow data (step 710), which the AI processes (step 720) to identify patterns and optimize functionalities. The AI then trains a model based on this data (step 730), enhancing its capabilities over time. The results from the Al are supplied back into the system (step 740), where they are used to refine and process connectors and flows further (step 750). This system ultimately enables automated communication, such as sending messages via Skype connectors or other third party connectors, and provides users with the ability to create custom flows effortlessly, leveraging Al-driven insights and automation for improved efficiency and performance.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “computer readable storage medium” may be any tangible medium (but not a signal medium—which is defined below) that can contain, or store a program. The terms “machine readable medium,” “computer-readable medium,” or “computer readable storage medium” are all non- transitory in their nature and definition. Non-transitory computer readable media comprise all computer-readable media except for a transitory, propagating signal.

The term “machine-readable signal” refers to any signal used to provide machine instructions and/or data to a programmable processor. A “computer readable signal medium” may be any computer readable medium that is not a computer readable storage medium and that can communicate, propagate, or transport a program.

To provide for interaction with a user, the systems and techniques described here can

be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A method for creation and management of connectors and flow processes in digital applications comprising:
inputting of connector and flow data;
processing said input and flow data by an artificial intelligence process;
identifying patterns by said artificial intelligence process;
optimizing functionalities by said artificial intelligence process;
training a model by said artificial intelligence based on said input and flow data;
enhancing capabilities of said model by said artificial intelligence over time;
supplying said results from said artificial intelligence back into said system;
refining and processing connectors and flows by said results.

2. The method of claim 1 further comprising enablement of automated communication and messages by third party connectors.

3. The method of claim 1 further comprising the step of providing users with the ability to create custom flows.

4. The method of claim 1 further comprising the step of leveraging artificial intelligence driven insights and automation for improved efficiency and performance.
